(19) United States
(12) Patent Application Publication
(10) Pub. No.: US 2015/0363408 A1
(43) Pub. Date: Dec. 17, 2015

(54) METHOD FOR UPLOADING MULTIMEDIA DATA, METHOD FOR PLAYING MULTIMEDIA DATA AND MULTIMEDIA PLAYING SYSTEM

(71) Applicant: HTC Corporation, Taoyuan County (TW)

(72) Inventor: Hsi-Kun Chen, Taoyuan County (TW)

(21) Appl. No.: 14/306,241

(22) Filed: Jun. 17, 2014

(51) Int. Cl. G06F 17/30; H04L 29/12; H04L 29/06

(52) U.S. Cl. CPC G06F 17/30058; H04L 65/403; H04L 61/609; G06F 17/30887

(57) ABSTRACT

The invention provides a method for uploading multimedia data for a user terminal. In the method, a multimedia data is generated and a trimmed multimedia data is edited from the multimedia data. A control signal is received. When the control signal indicates broadcasting a premiere information of the multimedia data, at least an internet user correlative to an user of the user terminal is informed about the premiere information and, at the same time, the trimmed multimedia data is shared to the at least internet user. When a communication status of the user terminal is capable of transmitting the multimedia data or when the control signal indicates directly uploading the multimedia data, the multimedia data is uploaded to a server.

### BACKGROUND OF THE INVENTION

1. Field of Invention

The present invention relates to methods for uploading and playing multimedia data and a system for using the same. More particularly, the present invention relates to a multimedia playing system uploading a multimedia data in a two-step way.

2. Description of Related Art

In human daily life, the electronic devices are widely used to generate a multimedia data such as a video-audio file. With the increasing popularity of social networks, people are used to sharing the multimedia data with each other. However, the file size of the multimedia data is usually large and it requires a relatively wide bandwidth to transmit the multimedia data to achieve the goal for sharing the multimedia data to friends. When the transmission bandwidth is not enough or the transmission condition is poor (i.e. the communication reception is poor or the transmission speed is low), it takes a lot of time to transmit a multimedia data with a bulk file size to the sever and the transmission efficiency is poor. Thus, it is hard to instantly share the multimedia data with people right after the multimedia data is generated. Furthermore, transmitting the multimedia data with a bulk file size in poor transmission condition leads to relatively high power consumption of the electronic device.

### SUMMARY OF THE INVENTION

The present invention is to provide a method for uploading multimedia data, a method for playing multimedia data and a multimedia playing system capable of providing instant information about the multimedia data to the internet users without being affected by the current internet transmission speed.

The invention provides a method for uploading multimedia data for a user terminal. In the method, a multimedia data is generated and a trimmed multimedia data is edited from the multimedia data. A control signal is received. When the control signal indicates broadcasting a premiere information of the multimedia data, at least an internet user correlative to an user of the user terminal is informed about the premiere information and, at the same time, the trimmed multimedia data is shared to the at least internet user. When a communication status of the user terminal is capable of transmitting the multimedia data or when the control signal indicates directly uploading the multimedia data, the multimedia data is uploaded to a server.

According to one embodiment of the present invention, the step of informing the at least internet user simultaneously with sharing the trimmed multimedia data to the at least internet user is performed through a social networking platform on which a social connection is built between the user and the at least internet users.

According to one embodiment of the present invention, the step of informing the at least internet user simultaneously with sharing the trimmed multimedia data to the at least internet user further comprises sharing the trimmed multimedia data along with a meta data of the multimedia data.

According to one embodiment of the present invention, the meta data includes geolocation information correlative to the multimedia data and owner information of the multimedia data.

According to one embodiment of the present invention, the step of informing the at least internet user simultaneously with sharing the trimmed multimedia data to the at least internet user further comprises providing a subscribing interface for the internet users to subscribe for watching a full version of the multimedia data.

The invention further provides a method for playing a multimedia data. In the method, a multimedia data is received along with a meta data of the multimedia data. At least a subscribing signal for subscribing for watching the multimedia data is received, wherein the subscribing signals include information of subscribers issuing the subscribing signal. The subscribers are informed that the multimedia data is ready to be played and a playing instruction of the multimedia data is provided.

According to one embodiment of the present invention, the playing instruction includes a web address where the multimedia data can be accessed.

According to one embodiment of the present invention, the meta data includes geolocation information correlative to the multimedia data and owner information of the multimedia data.

The invention also provides a multimedia playing system comprising a user terminal and a server. The user terminal is used for generating a multimedia data, editing a trimmed multimedia data from the multimedia data, informing premiere information of the multimedia data to at least an internet user correlative to an user of the user terminal simultaneously with sharing the trimmed multimedia data to the at least internet user when a control signal indicating broadcasting the premiere information is received, and uploading the multimedia data when a communication status of the user terminal is capable of transmitting the multimedia data or when the control signal indicating directly uploading the multimedia data is received. The server is used for receiving the uploaded multimedia data from the user terminal, receiving at least subscribing signal including information of subscribers for subscribing for watching the multimedia data and informing the subscribers that the multimedia data is ready to be played and providing a playing instruction of the multimedia data according to the information of the subscribers.

According to one embodiment of the present invention, the user terminal informs the at least internet user simultaneously with sharing the trimmed multimedia data to the at least internet user through a social networking platform on which a social connection is built between the user and the at least internet users.

According to one embodiment of the present invention, the user terminal shares the trimmed multimedia data along with a meta data of the multimedia data.

According to one embodiment of the present invention, the meta data includes geolocation information correlative to the multimedia data and owner information of the multimedia data.

According to one embodiment of the present invention, the server receives the uploaded multimedia data along with the meta data of the multimedia data.

According to one embodiment of the present invention, the playing instruction includes a web address where the multimedia data can be accessed.

In the present invention, the trimmed multimedia data is edited from the multimedia data and is the short version/trailer of the multimedia data. Once the multimedia data is generated, the user can decide either to upload the multimedia data to the server directly or to share the trimmed multimedia data to the internet users first and to upload the multimedia data to the server later when the communication status of the user terminal is capable of transmitting the multimedia data. Once the user decides to announce the premiere information of the multimedia data and to share the trimmed multimedia data to the internet users first and to upload the multimedia data to the server later when the communication status of the user terminal is capable of transmitting the multimedia data, the internet users are informed about the premiere information of the multimedia data along with the trimmed multimedia data. Therefore, the internet users can instantly receive the upcoming premiere of the multimedia data. Furthermore, the user of the user terminal generating the multimedia data is not burdened with transmitting the multimedia data, which, usually, requires a relatively wide bandwidth in transmission, in a relatively poor current communication status; the multimedia data can be transmitted to the server later when the communication status is capable of transmitting the multimedia data. Thus, the internet users are informed instantly about the premiere of the multimedia data and the communication resources can be managed effectively.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a multimedia playing system according to one embodiment of the present invention.

FIG. 2 is a flow chart showing a method for uploading multimedia data for a user terminal according to one embodiment of the present invention.

FIG. 3 is a flow chart showing a method for playing a multimedia data according to one embodiment of the present invention.

### DESCRIPTION OF THE PREFERRED EMBODIMENTS

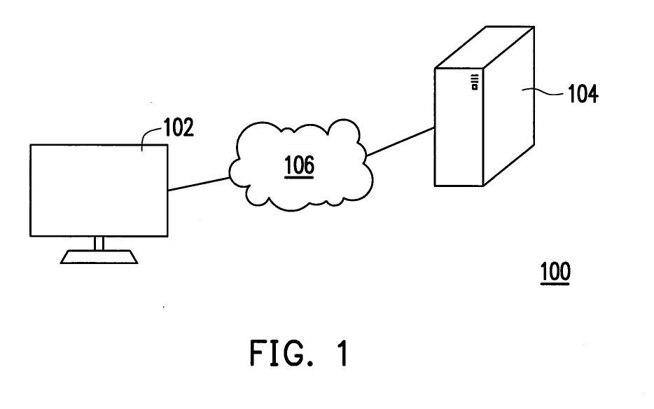

FIG. 1 is a schematic diagram showing a multimedia playing system according to one embodiment of the present invention. As shown in FIG. 1, a playing system 100 of the present embodiment includes at least a user terminal 102 and a server 104 and the user terminal communicates with the server 104 through the Internet 106. In FIG. 1 of the present embodiment, the user terminal 102 is depicted by a personal computer. However, the figure representation of user terminal 102 does not limit the scope of the user terminal 102. More clearly, the user terminal 102 can be, for example, a personal computer, a tablet personal computer (tablet PC), a smart phone or any electronic device which is capable of transmitting data to other electronic devices. The sever 104 can be, for example, can be a personal computer or any electronic device capable of transmitting data, receiving data and processing data.

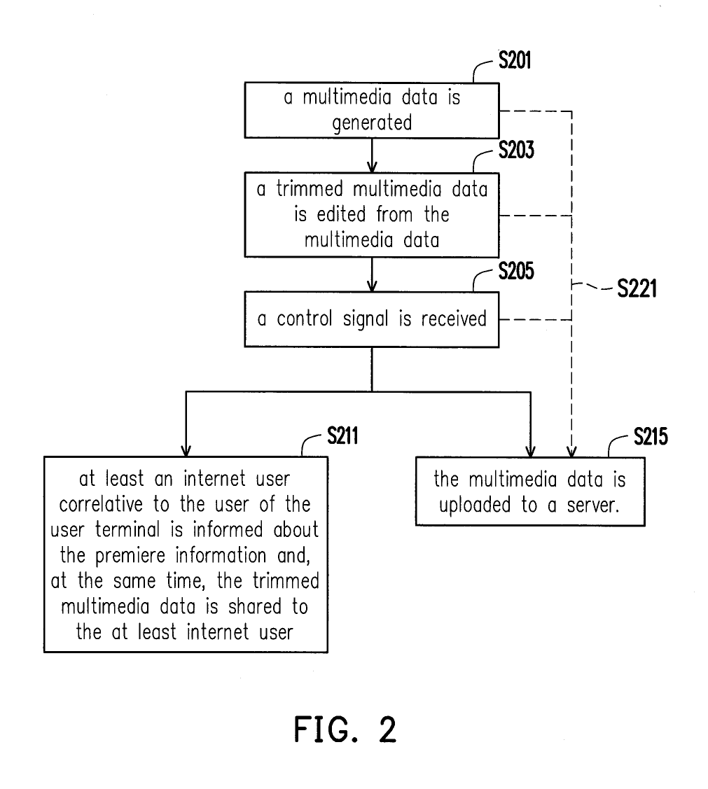

FIG. 2 is a flow chart showing a method for uploading multimedia data for a user terminal according to one embodiment of the present invention. As shown in FIG. 1 and FIG. 2, in the step S201, a multimedia data is generated by the user terminal 102 and, in the step S203, a trimmed multimedia data is edited from the multimedia data by the user terminal 102. It should be noticed that the multimedia data can be a video-audio file in mpeg (Moving Picture Experts Group) standard or any other video-audio file format supported by the user terminal. Furthermore, the trimmed multimedia data is a short version or trailer of the multimedia data. For instance, the multimedia data is composed of a plurality of contiguous frames and the trimmed multimedia data is obtained by the user of the user terminal 102 manually picking a portion of the frames from the multimedia data or by the user terminal 102 automatically picking a portion of the frames from the multimedia data. Thus, the trimmed multimedia data can be a video-audio file in mpeg standard or a motion picture set in the graphics interchange format (GIF). Therefore, the trimmed multimedia data is much smaller than the multimedia data in file size and is much more feasible for being transmitted through the internet especially when the communication quality is not good at all.

Then, in the step S205, a control signal is received by the user terminal 102. For instance, the user terminal 102 displays a pop-up window asking the user to determine whether the multimedia data is directly transmitted to the server 104 or the premiere information of the multimedia data is broadcasted first and the multimedia data is transmitted later as the communication status is available for transmitting a bulk file. Upon the pop-up window, the user can choose either to directly transmit the multimedia data anyway or to broadcast the premiere information of the multimedia data first. By making the decision, the control signal indicating either broadcasting the premiere information of the multimedia data or directly uploading the multimedia data to the server is generated and is received by the user terminal 102.

In the step S211, when the control signal indicates broadcasting a premiere information of the multimedia data, at least an internet user correlative to the user of the user terminal 102 is informed about the premiere information by the user terminal 102 and, at the same time, the trimmed multimedia data is shared to the at least internet user by the user terminal 102. Noticeably, the connection between the aforementioned internet users and the user of the user terminal is built on a social networking platform. The social networking platform can be, for example, Facebook™, Google+™, Tweeter™ and all kinds of platforms on which the registered users can share information, digital files, post public or private messages and communicate with each other.

Moreover, the steps of informing the internet users correlative to the user about the premiere information of the multimedia data and sharing the trimmed multimedia data to the internet users can be done through the social networking platform. Also, it should be noticed that the social networking platform can be run on the server 104 or on the server other than the server 104.

In addition, in another embodiment, the trimmed multimedia data is shared to the internet users along with a meta data of the multimedia data. Noticeably, the meta data includes geolocation information of the multimedia data and owner information of the multimedia data. The geolocation information of the multimedia data can be, for example, the geographic location where the multimedia data gets created, such as a geographic coordinate retrieved from a global positioning system or a geographic coordinate being located by several base stations, which is not limited thereto. Also, the owner information of the multimedia data can be, for example, the copyright information of the multimedia data. Further, in the other embodiment, while the internet users are informed about the premiere information of the multimedia data and the trimmed multimedia data is shared to the internet users, a subscribing interface is further provided along with the shared trimmed multimedia data for the internet users to subscribe for watching a full version of the multimedia data.

In the step S215, when the control signal indicates directly uploading the multimedia data, the multimedia data is uploaded to a server 104 by the user terminal 102. Alternatively, in the step S212, in any time slot after the step S201 of generating the multimedia data by the user terminal 102, the multimedia data is uploaded to a server 104 by the user terminal 102 when the communication status of the user terminal 102 is capable of transmitting the multimedia data. That is, when the communication status of the user terminal 102 is feasible for transmitting bulk data, the multimedia data is directly transmitted to the server 104. Furthermore, the multimedia data is transmitted to the server 104 along with the meta data as mentioned above.

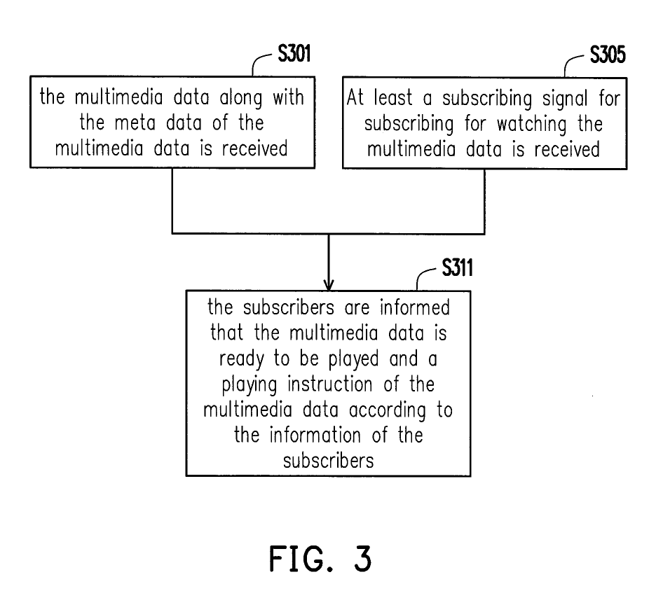

FIG. 3 is a flow chart showing a method for playing a multimedia data according to one embodiment of the present invention. As shown in FIG. 1 and FIG. 3, in the step S301, the multimedia data along with the meta data of the multimedia data is received by the server 104. In the step S305, at least a subscribing signal for subscribing for watching the multimedia data is received by the server 104. It should be noticed that the subscribing signals include information of subscribers (i.e. the people among the internet users correlative to the user or the people receive the premiere information sent by the user terminal 102) issuing the subscribing signal respectively and further include the information about the multimedia data which the subscribers is subscribing for. That is, the aforementioned information about the multimedia data can be, for example, the meta data of the multimedia data which the subscribers is subscribing for.

After the step S301 of receiving the multimedia data from the user terminal 102 by the server 104, in the step S311, the server 104 informs the subscribers that the multimedia data which the subscribers subscribe for is ready to be played and a playing instruction of the multimedia data according to the information of the subscribers. It should be noticed that the playing instruction includes, for example, a web address where the multimedia data can be accessed in the server 104. Upon the playing instruction, the subscribers can access/play the multimedia data on the server 104.

In the present invention, the trimmed multimedia data is edited from the multimedia data and is the short version/trailer of the multimedia data. Once the multimedia data is generated, the user can decide either to share the trimmed multimedia data to the internet users first and latter to upload the multimedia data to the server when the communication status of the user terminal is capable of transmitting the multimedia data or directly to upload the multimedia data to the server anyway. Since the user decides to announce the premiere information of the multimedia data and to share the trimmed multimedia data to the internet users first and latter to upload the multimedia data to the server when the communication status of the user terminal is capable of transmitting the multimedia data, the internet users are informed about the premiere information of the multimedia data along with the trimmed multimedia data. Therefore, the internet users can instantly acknowledge the upcoming premiere of the multimedia data. Furthermore, the user of the user terminal generating the multimedia data is not struggle with transmitting the multimedia data, which, usually, requires a relatively wide bandwidth in transmission, in a relatively poor current communication status and the multimedia data can be transmitted to the server later when the communication status is capable of transmitting the multimedia data. Thus, the internet users are informed instantly about the premiere of the multimedia data and the communication resources can be will managed.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for uploading multimedia data for a user terminal, comprising:
generating a multimedia data;
editing a trimmed multimedia data from the multimedia data;
receiving a control signal;
informing premiere information of the multimedia data to at least an internet user correlative to an user of the user terminal simultaneously with sharing the trimmed multimedia data to the at least internet user when the control signal indicates broadcasting the premiere information; and
uploading the multimedia data to a server when a communication status of the user terminal is capable of transmitting the multimedia data or when the control signal indicates directly uploading the multimedia data.

2. The method of claim 1, wherein the step of informing the at least internet user simultaneously with sharing the trimmed multimedia data to the at least internet user is performed through a social networking platform on which a social connection is built between the user and the at least internet users.

3. The method of claim 1, wherein the step of informing the at least internet user simultaneously with sharing the trimmed multimedia data to the at least internet user further comprises sharing the trimmed multimedia data along with a meta data of the multimedia data.

4. The method of claim 3, wherein the meta data includes geolocation information correlative to the multimedia data and owner information of the multimedia data.

5. The method of claim 1, wherein the step of informing the at least internet user simultaneously with sharing the trimmed multimedia data to the at least internet user further comprises providing a subscribing interface for the internet users to subscribe for watching a full version of the multimedia data.

6. A method for playing a multimedia data, comprising:
receiving a multimedia data along with a meta data of the multimedia data;
receiving at least a subscribing signal for subscribing for watching the multimedia data, wherein the subscribing signals include information of subscribers issuing the subscribing signal; and
informing the subscribers that the multimedia data is ready to be played; and
providing a playing instruction of the multimedia data according to the information of the subscribers.

7. The method of claim 6, wherein the playing instruction includes a web address where the multimedia data can be accessed.

8. The method of claim 6, wherein the meta data includes geolocation information correlative to the multimedia data and owner information of the multimedia data.

9. A multimedia playing system, comprising:
a user terminal, generating a multimedia data, editing a trimmed multimedia data from the multimedia data, informing premiere information of the multimedia data to at least an internet user correlative to an user of the user terminal simultaneously with sharing the trimmed multimedia data to the at least internet user when a control signal indicating broadcasting the premiere information is received, and uploading the multimedia data when a communication status of the user terminal is capable of transmitting the multimedia data or when the control signal indicating directly uploading the multimedia data is received; and
a server, receiving the uploaded multimedia data from the user terminal, receiving at least a subscribing signal including information of subscribers for subscribing for watching the multimedia data and informing the subscribers that the multimedia data is ready to be played and providing a playing instruction of the multimedia data according to the information of the subscribers.

10. The multimedia playing system of claim 9, wherein the user terminal informs the at least internet user simultaneously with sharing the trimmed multimedia data to the at least internet user through a social networking platform on which a social connection is built between the user and the at least internet users.

11. The multimedia playing system of claim 9, wherein the user terminal shares the trimmed multimedia data along with a meta data of the multimedia data.

12. The multimedia playing system of claim 11, wherein the meta data includes geolocation information correlative to the multimedia data and owner information of the multimedia data.

13. The multimedia playing system of claim 11, wherein the server receives the uploaded multimedia data along with the meta data of the multimedia data.

14. The multimedia playing system of claim 9, wherein the playing instruction includes a web address where the multimedia data can be accessed.
